(19) United States
(12) Patent Application Publication
(10) Pub. No.: US 2026/0292113 A1
(43) Pub. Date: Sep. 24, 2026

(54) PROJECTION DISPLAY METHOD AND PROJECTION DISPLAY DEVICE

(71) Applicant: Anker Innovations Technology Co., Ltd., SHENZHEN (CN)

(72) Inventors: Huajin HUANG, SHENZHEN (CN); Hualiang HUANG, SHENZHEN (CN); Xiao LI, SHENZHEN (CN)

(21) Appl. No.: 19/574,441

(22) Filed: Mar. 23, 2026

(30) Foreign Application Priority Data
Mar. 21, 2025 (CN) 202510344204.5

(51) Int. Cl. H04N 9/31

(52) U.S. Cl. CPC H04N 9/3185

(57) ABSTRACT

The application relates to a projection display method and a projection display device. The method is applied to the projection display device, and includes: obtaining point cloud data along a projection direction of the projection display device, the point cloud data characterizing three-dimensional spatial positions of a plurality of detection points along the projection direction; identifying a target projection plane based on the point cloud data; identifying an obstacle point not located on the target projection plane from the plurality of detection points based on the target projection plane and the point cloud data; controlling, in response to determining that the obstacle point is within a current projection range, the projection display device to project an image that avoids the obstacle point.

### CROSS REFERENCE TO RELATED APPLICATIONS

The present disclosure claims priority to Chinese Patent Application No. 202510344204.5, filed on Mar. 21, 2025, the entire contents of which are incorporated herein by reference.

### TECHNICAL FIELD

The present disclosure relates to the technical field of display devices, and in particular to a projection display method and a projection display device.

### BACKGROUND

With the continuous development of display devices, projection display devices are gradually emerging. When a placement distance between a projection lens and a projection display area is relatively long, or when an elevation angle of the projection lens is relatively large, a situation often occurs in which a partial area of a projection image is displayed on an obstacle, for example, on a ceiling or the like, resulting in a poor projection effect.

At present, a camera may be provided to identify a projection display area and the obstacle, and based thereon, the projection image is projected to a correct projection display area.

However, some obstacles may have a color similar to a color of the projection display area. For example, when the projection display area is a wall surface, the wall surface may have a color similar to a color of the ceiling. In such a case, the projection display area and the obstacle may not be accurately distinguished based on an image captured by the camera, which may cause the projection display device to fail to accurately project the projection image to the correct projection display area, thus affecting the projection effect.

### SUMMARY

In a first aspect, the embodiments of the present disclosure may provide the projection display method applied to the projection display device. The method may include: obtaining point cloud data along a projection direction of the projection display device, the point cloud data characterizing three-dimensional spatial positions of a plurality of detection points along the projection direction; identifying a target projection plane based on the point cloud data; identifying an obstacle point not located on the target projection plane from the plurality of detection points based on the target projection plane and the point cloud data; controlling, in response to determining that the obstacle point is within a current projection range, the projection display device to project an image that avoids the obstacle point.

In a second aspect, the embodiments of the present disclosure may provide the projection display device including an optical engine, a memory, and a processor. The memory may be configured to store a computer program, and the processor may be configured to execute the computer program to implement the following operations: obtaining point cloud data along a projection direction of the projection display device, the point cloud data characterizing three-dimensional spatial positions of a plurality of detection points along the projection direction; identifying a target projection plane based on the point cloud data; identifying an obstacle point not located on the target projection plane from the plurality of detection points based on the target projection plane and the point cloud data; controlling, in response to determining that the obstacle point is within a current projection range, the projection display device to project an image that avoids the obstacle point.

### BRIEF DESCRIPTION OF THE DRAWINGS

In order to more clearly illustrate the technical solutions in the embodiments of the present disclosure or in the related art, the drawings required for describing the embodiments of the present disclosure or the related art may be briefly introduced below. Obviously, the drawings in the following description may be some embodiments of the present disclosure. For those of ordinary skill in the art, other drawings may also be obtained based on these drawings without creative work.

FIG. 1 is a schematic view of a position distribution of a projection display area and an obstacle area according to some embodiments of the present disclosure.

FIG. 2 is a schematic flow chart of a projection display method according to some embodiments of the present disclosure.

FIG. 3 is a schematic flow chart of detecting whether an obstacle point is within a current projection range according to some embodiments of the present disclosure.

FIG. 4 is a schematic view of field of view angles of a projection lens and a detection apparatus of an optical engine according to some embodiments of the present disclosure.

FIG. 5 is a schematic structure view of a projection display apparatus according to some embodiments of the present disclosure.

FIG. 6 is a schematic structure view of a projection display device according to some embodiments of the present disclosure.

### DETAILED DESCRIPTION

In order to make the objectives, technical solutions, and advantages of the present disclosure clearer, the present disclosure will be described in detail below in conjunction with the accompanying drawings and the embodiments. It should be understood that the embodiments described herein may be used only to explain the present disclosure, and may not be used to limit the present disclosure.

The projection display device in the embodiments may be a projection display device with a motion mechanism or a projection display device without a motion mechanism. The motion mechanism may be configured to adjust an elevation angle of a projection lens, so that a projection range may be adjusted. For the projection display device with the motion mechanism, when the elevation angle of the projection lens is relatively large, or when a placement distance between the projection lens and a projection display area is relatively long, a situation may possibly occur in which the projection image is not correctly displayed. That is, a partial area of the projection image may be displayed on an obstacle. For the projection display device without the motion mechanism, when the placement distance between the projection lens and the projection display area is relatively long, the situation may possibly occur in which the projection image is not correctly displayed. That is, a partial area of the projection image may be displayed on the obstacle.

At present, an image may be captured by a camera, and a position of the obstacle may be identified based on the captured image, so that the projection display device may be controlled to project the projection image that avoids the obstacle. However, once the obstacle has a color similar to a color of a correct projection display area, the position of the obstacle may not be accurately identified based on the captured image, which may cause the projection display device to fail to accurately adjust the projection image to the correct projection display area, thus affecting the projection display effect.

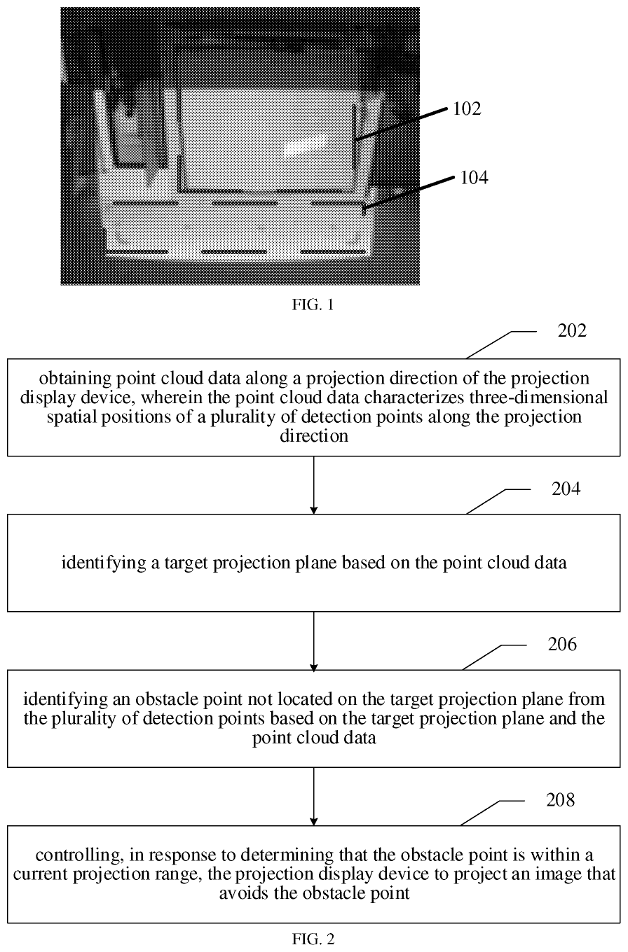

As an example, as shown in FIG. 1, FIG. 1 may show a captured image captured by a camera on a projection display device. It may be seen that both a projection display area 102 and an obstacle (e.g., ceiling) area 104 in the captured image may be white. A boundary line between the projection display area 102 and the obstacle area 104 may be relatively blurred. Therefore, it may be difficult to identify accurate positions of the projection display area 102 and the obstacle area 104 based on the captured image. Thus, it may be difficult to accurately distinguish the projection display area 102 and the obstacle area 104.

In some embodiments, as shown in FIG. 2, a projection display method may be provided. The method may be applied to a projection display device. The projection display method may include operations executed by the following blocks.

At block 202, point cloud data along a projection direction of the projection display device may be obtained. The point cloud data may characterize three-dimensional spatial positions of a plurality of detection points along the projection direction.

The projection display device may include an optical engine. A detection apparatus may be disposed on the optical engine. The detection apparatus may detect the three-dimensional spatial positions of the plurality of detection points along the projection direction, so as to form the point cloud data. The detection apparatus may include a depth sensor, a depth camera, a camera assembly including a plurality of cameras, an infrared laser radar, or a millimeter wave radar, which may not be limited herein.

As an example, by taking the depth sensor as the detection apparatus, the depth sensor may emit an infrared ray with a preset horizontal field of view angle and a preset vertical field of view angle. In this way, a returned distance may be measured via a lattice of the depth sensor with a preset size. Since each point in the lattice may correspond to one detection point, three-dimensional spatial position information of the plurality of detection points may be detected. That is, two-dimensional plane position of each point in the lattice plus the measured returned distance (i.e., depth information) may form the three-dimensional spatial position information, and the point cloud data may be obtained.

As an example, the preset horizontal field of view angle may be 45 degrees, 50 degrees, or the like. The preset vertical field of view angle may be 45 degrees, 50 degrees, or the like. The lattice with the preset size may be an 8*8 lattice, a 10*10 lattice, or the like.

At block 204, a target projection plane may be identified based on the point cloud data.

As an example, the operation at block 204 may include: performing plane fitting on the plurality of detection points based on the point cloud data to obtain a plurality of fitting planes; determining a fitting plane including the most detection points as the target projection plane. A projection plane position of the target projection plane or a spatial parameter of the target projection plane may be determined based on the point cloud data.

As an example, the projection plane position of the target projection plane may be represented by a plane equation.

As an example, the operation of identifying the target projection plane based on the point cloud data may include the following operations.

A plurality of sampling points may be determined from the plurality of detection points, and three-dimensional spatial position information of the plurality of sampling points may be obtained from the point cloud data; plane fitting may be performed based on the three-dimensional spatial position information of the plurality of sampling points to obtain the target projection plane.

A sampling mode to determine the sampling points in the embodiments may be random sampling or uniform sampling, which may not be limited herein.

In some embodiments, the plurality of sampling points may be sampled from the plurality of detection points based on a preset sampling mode. The three-dimensional spatial position information of the plurality of sampling points may be obtained from the point cloud data. The plane fitting may be performed based on the three-dimensional spatial position information, enabling a distance statistical parameter from all the sampling points to a fitting plane to be minimized. The fitting plane may function as the target projection plane of the projection display device. A plane equation of the target projection plane may function as position information characterizing the projection plane position. In this way, in the embodiments, a part of the detection points may be sampled from the plurality of detection points as the sampling points, and the plane fitting may be performed based on three-dimensional position data of the sampling points, without performing plane fitting on all the detection points, so that the efficiency of plane fitting may be improved.

At block 206, an obstacle point not located on the target projection plane may be identified from the plurality of detection points based on the target projection plane and the point cloud data.

The projection plane position may be represented by a projection plane equation of the target projection plane. The point cloud data may include three-dimensional position information of the plurality of detection points.

As an example, the operation at block 206 may include: for each detection point, identifying whether three-dimensional position information of the detection point conforms to the projection plane equation of the target projection plane; determining that the detection point is located on the target projection plane in response to the three-dimensional position information of the detection point conforming to the projection plane equation of the target projection plane; determining that the detection point is the obstacle point not located on the target projection plane in response to the three-dimensional position information of the detection point not conforming to the projection plane equation of the target projection plane.

At block 208, the projection display device may be controlled to project an image that avoids the obstacle point in response to determining that the obstacle point is within a current projection range.

As an example, in response to determining that the obstacle point is within the current projection range of the projection display device, it may indicate that the obstacle point belonging to an obstacle may appear in a current projection image of the projection display device. Therefore, the operation at block 208 may include: controlling the projection display device to project the image that avoids the obstacle point by adjusting at least one of a projection parameter of the projection display device or the elevation angle of the projection lens.

As an example, the projection parameter may include a projection ratio, a projection image aspect ratio, and an image zoom ratio.

In the embodiments, the point cloud data along the projection direction of the projection display device may be obtained. The point cloud data may characterize the three-dimensional spatial positions of the plurality of detection points along the projection direction, so that the target projection plane of the projection display device may be accurately identified based on the point cloud data. In this way, the obstacle point not located on the target projection plane may be identified from the plurality of detection points based on the target projection plane and the point cloud data. The obstacle point may be a point of an obstacle. Based on this, the embodiments may achieve the purpose of distinguishing the target projection plane from the obstacle based on the point cloud data. Moreover, since a process of distinguishing the target projection plane from the obstacle may not rely on a visual factor such as a color, the target projection plane and the obstacle may be accurately distinguished even when the obstacle has a color similar to that of the target projection plane, so that the target projection plane and the obstacle may be distinguished more accurately. Further, in response to determining that the obstacle point is within the current projection range of the projection display device, the projection display device may be controlled to project the image that avoids the obstacle point, so that the projection image of the projection display device may be controlled to be accurately displayed on the correct projection display area, and thus the projection display effect may be improved.

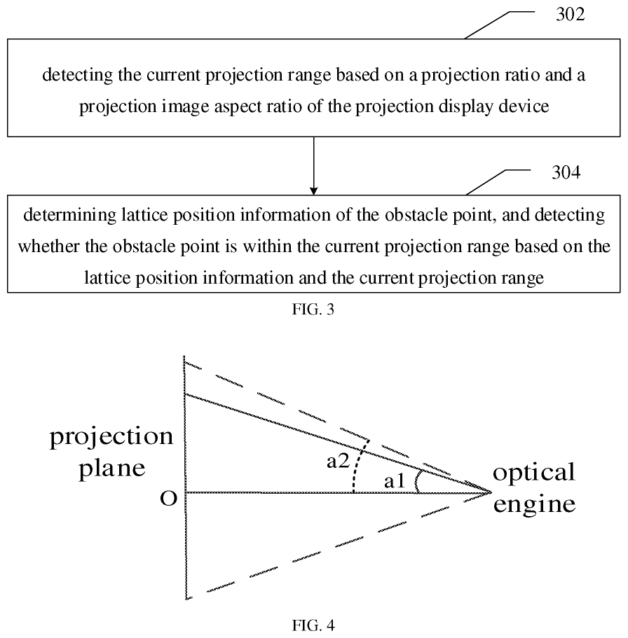

In some embodiments, as shown in FIG. 3, before controlling, in response to determining that the obstacle point is within the current projection range, the projection display device to project the image that avoids the obstacle point, the projection display method may further include operations executed by the following blocks.

At block 302, the current projection range may be detected based on a projection ratio and a projection image aspect ratio of the projection display device.

The current projection range of the projection display device may be represented by a current horizontal field of view angle and a current vertical field of view angle of the projection display device.

As an example, the operation at block 302 may include: detecting the current horizontal field of view angle of the projection display device based on the projection ratio of the projection display device; detecting the current vertical field of view angle of the projection display device based on the projection ratio and the projection image aspect ratio of the projection display device.

As an example, a calculation formula configured to detect the current horizontal field of view angle of the projection display device based on the projection ratio of the projection display device may be as follows.

$$tan ( \frac{H F O V}{2} ) = \frac{1}{2 {R}_{p}}$$

HFOV may be the current horizontal field of view angle. Rₚ may be the projection ratio.

As an example, a calculation formula configured to detect the current vertical field of view angle of the projection display device based on the projection ratio and the projection image aspect ratio of the projection display device may be as follows.

$$tan ( V F O V ) = \frac{1}{{R}_{i} * {R}_{p}}$$

VFOV may be the current vertical field of view angle. Rₚ may be the projection ratio. Rᵢ may be the projection image aspect ratio.

At block 304, lattice position information of the obstacle point may be determined, and whether the obstacle point is within the current projection range may be detected based on the lattice position information and the current projection range.

The lattice position information may include position information such as a row number or a column number of the obstacle point in the lattice.

As an example, the operation at block 304 may include: determining a first field of view angle of the projection lens in the optical engine along a preset direction and a second field of view angle of the detection apparatus corresponding to the point cloud data in the optical engine along the preset direction; detecting a point field of view angle of the obstacle point based on the second field of view angle and the lattice position information of the obstacle point; detecting whether the obstacle point is within the current projection range based on the first field of view angle and the point field of view angle.

It should be noted that the preset direction may be a horizontal direction or a vertical direction.

As an example, the projection display device may include the optical engine. The optical engine may include the projection lens and the detection apparatus. The detection apparatus may be configured to detect the point cloud data. The current projection range may include the first field of view angle of the projection display device. The operation of detecting whether the obstacle point is within the current projection range based on the lattice position information and the current projection range may include the following operations.

A view angle difference between the detection apparatus and the projection lens may be determined, and the second field of view angle of the detection apparatus along the preset direction may be determined based on the view angle difference and the first field of view angle. The point field of view angle of the obstacle point along the preset direction may be detected based on the lattice position information and the second field of view angle. It may be determined that the obstacle point is within the current projection range in response to the point field of view angle being less than or equal to the first field of view angle. It may be determined that the obstacle point is not within the current projection range in response to the point field of view angle being greater than the first field of view angle.

Since installation positions of the detection apparatus and the projection lens may be arranged to be relatively fixed, a known view angle difference may usually exist between a field of view angle of the detection apparatus and a field of view angle of the projection lens. The first field of view angle may be the field of view angle of the projection lens along the preset direction. The second field of view angle may be the field of view angle of the detection apparatus along the preset direction.

In some embodiments, the view angle difference between the detection apparatus and the projection lens may be determined. The view angle difference and the first field of view angle may be summed to obtain the second field of view angle of the detection apparatus along the preset direction. The point field of view angle of the obstacle point along the preset direction may be detected based on a lattice size corresponding to the point cloud data, the lattice position information, and the second field of view angle. It may be determined that the obstacle point is within the current projection range in response to the point field of view angle being less than or equal to the first field of view angle. It may be determined that the obstacle point is not within the current projection range in response to the point field of view angle being greater than the first field of view angle.

As an example, since both the detection apparatus and the projection lens may be disposed on the optical engine, the detection apparatus and the projection lens may be regarded as the same point when determining the field of view angle. By taking the preset direction as a vertical direction, the first field of view angle may be an included angle between a highest projection sight line of the projection lens along the vertical direction and a line of the optical engine perpendicular to a target projection image. The second field of view angle may be an included angle between a highest detection sight line of the detection apparatus along the vertical direction and the line of the optical engine perpendicular to the target projection image. The point field of view angle may be an included angle between a connecting line between the obstacle point and the detection apparatus and the line of the optical engine perpendicular to the target projection image.

As an example, as shown in FIG. 4, by taking the vertical direction as the preset direction, a1 may be the first field of view angle, and a2 may be the second field of view angle. Assuming that the lattice size is 8*8, a field of view angle range occupied by obstacle points in each row of the lattice may be V/8. V may be a total field of view angle of the detection apparatus, which may include a field of view angle above a point O (i.e., the second field of view angle) and may also include a field of view angle below the point O. In this way, when the lattice position information of the obstacle point indicates that the obstacle point is a point in a highest row along the vertical direction, a point field of view angle of the obstacle point may be a2-V/8. When the lattice position information of the obstacle point indicates that the obstacle point is a point in a second highest row along the vertical direction, a point field of view angle of the obstacle point may be a2-2*V/8. Based on this, the point field of view angle may be compared with the first field of view angle to confirm whether the obstacle point is within the current projection range of the projection display device.

In the embodiments, the current projection range of the projection display device may be detected based on the projection ratio and the projection image aspect ratio of the projection display device. Thus, after determining the lattice position information of the obstacle point, whether the obstacle point is within the current projection range may be determined quantitatively based on the lattice position information and the current projection range. In this way, accurate determination of whether the obstacle point is within the current projection range may be achieved, which may lay a foundation for detecting whether an obstacle exists in the current projection image of the projection display device.

In some embodiments, the projection display device may include a motion mechanism. The current projection range may include the first field of view angle of the projection display device. The operation of controlling the projection display device to project the image that avoids the obstacle point may include the following operations.

An adjustment angle of the motion mechanism may be determined based on a difference between the first field of view angle and the point field of view angle of the obstacle point. The current projection range of the projection display device may be adjusted by using the motion mechanism based on the adjustment angle in response to the adjustment angle not exceeding an adjustment angle limit value of the motion mechanism, enabling the projection image of the projection display device to avoid the obstacle point.

The projection display device may include the motion mechanism. The motion mechanism may be configured to adjust the elevation angle of the projection lens, so as to adjust a projection position of the projection image of the projection display device. The adjustment angle limit value of the motion mechanism may be a difference between a current angle and a limit angle of the projection lens. For example, assuming that a current angle of the projection lens is 90 degrees and a limit angle of the projection lens is 100 degrees, the adjustment angle limit value of the motion mechanism may be 10 degrees.

In some embodiments, the difference between the point field of view angle of the obstacle point and the first field of view angle may be calculated, and the difference may function as the adjustment angle of the motion mechanism. In response to the adjustment angle not exceeding the adjustment angle limit value of the motion mechanism, the elevation angle of the projection lens (or the optical engine) may be adjusted by using the motion mechanism based on the adjustment angle, so that the projection image of the projection display device may avoid the obstacle point. In this way, the projection image of the projection display device may be controlled to accurately avoid the obstacle point only by using the motion mechanism, so that the projection image of the projection display device may be accurately projected to a correct projection display position.

In addition, it should be noted that an optical zoom of the projection display device may usually have a limit, that is, there may be a maximum projection ratio. The optical zoom may usually not be performed after the projection display device reaches the maximum projection ratio.

As an example, the projection display device may perform optical zooming, in response to the adjustment angle exceeding the adjustment angle limit value of the motion mechanism, the motion mechanism may be adjusted to the adjustment angle limit value. An angle difference between the adjustment angle and the adjustment angle limit value may be calculated. A first adjustment amount of a projection parameter of the projection display device may be calculated based on the angle difference. The projection parameter may include at least one of the projection ratio or the projection image aspect ratio. In response to the first adjustment amount not exceeding an adjustment amount limit value of the projection parameter, the projection parameter of the projection display device may be adjusted based on the first adjustment amount to adjust a projection display position of the projection image of the projection display device, so that the projection image of the projection display device may avoid the obstacle point. In this way, in the embodiments, when the motion mechanism do not adjust a projection image position, an optical zoom function of the projection display device may be combined to adjust the projection image of the projection display device to an accurate projection display position.

As an example, by taking the projection ratio as the projection parameter to be adjusted, the first adjustment amount of the projection parameter of the projection display device may be calculated based on the angle difference as follows.

$$tan ( α - θ ) = \frac{1}{{R}_{i} * {R}_{p}}$$

α may be a first field of view angle before adjusting the projection ratio of the projection display device. θ may be the angle difference between the adjustment angle and the adjustment angle limit value. Rᵢ may be the projection image aspect ratio. Rₚ may be an adjusted projection ratio. The first adjustment amount of the projection ratio may be obtained by calculating a difference between the adjusted projection ratio and the projection ratio before adjustment.

In some embodiments, in response to the first adjustment amount exceeding the adjustment amount limit value of the projection parameter, the projection parameter may be adjusted to the adjustment amount limit value. Digital zooming may be performed on the projection image of the projection display device, so that the projection image of the projection display device may avoid the obstacle point. In this way, in the embodiments, three modes, including adjusting the elevation angle of the projection lens by the motion mechanism, optical zooming, and performing digital zooming on the projection image, may be combined to adjust the projection image position of the projection display device, so as to ensure that the projection image of the projection display device may be accurately adjusted to a correct projection display position.

As an example, when the projection display device do not perform optical zooming, the method may further include the following operations.

The motion mechanism may be adjusted to the adjustment angle limit value in response to the adjustment angle exceeding the adjustment angle limit value of the motion mechanism. The angle difference between the adjustment angle and the adjustment angle limit value may be determined. Digital zooming may be performed on the projection image of the projection display device based on the angle difference, so that the projection image of the projection display device may avoid the obstacle point.

In some embodiments, in response to the adjustment angle exceeding the adjustment angle limit value of the motion mechanism, the motion mechanism may be adjusted to the adjustment angle limit value, and the angle difference between the adjustment angle and the adjustment angle limit value may be calculated and determined. A digital zoom ratio may be determined based on the angle difference. Digital zooming may be performed on the projection image of the projection display device, so that the projection image of the projection display device may avoid the obstacle point. In this way, in the embodiments, two modes, including adjusting the elevation angle of the projection lens by the motion mechanism and performing digital zooming on the projection image, may be combined to adjust the projection image position of the projection display device, so as to ensure that the projection image of the projection display device may be accurately adjusted to a correct projection display position.

In some embodiments, the projection display device may not include a motion mechanism, and the current projection range may include the first field of view angle of the projection display device. The operation of controlling the projection display device to project the image that avoids the obstacle point may include the following operations.

A second adjustment amount of the projection parameter of the projection display device may be detected based on the difference between the first field of view angle and the point field of view angle of the obstacle point. The projection parameter may include at least one of the projection ratio or the projection image aspect ratio. In response to the second adjustment amount not exceeding the adjustment amount limit value of the projection parameter, the projection parameter of the projection display device may be adjusted based on the second adjustment amount, so that the projection image of the projection display device may avoid the obstacle point. In response to the second adjustment amount exceeding the adjustment amount limit value of the projection parameter, the projection parameter may be adjusted to the adjustment amount limit value of the projection parameter, and digital zooming may be performed on the projection image of the projection display device, so that the projection image of the projection display device may avoid the obstacle point.

In some embodiments, a target angle difference may be obtained by calculating the difference between the first field of view angle and the point field of view angle of the obstacle point. The second adjustment amount of the projection parameter of the projection display device may be calculated based on the target angle difference. The projection parameter may include at least one of the projection ratio or the projection image aspect ratio. In response to the second adjustment amount not exceeding the adjustment amount limit value of the projection parameter, the projection parameter of the projection display device may be adjusted based on the second adjustment amount, so that the projection image of the projection display device may avoid the obstacle point. In response to the second adjustment amount exceeding the adjustment amount limit value of the projection parameter, the projection parameter may be adjusted to the adjustment amount limit value of the projection parameter. A digital zoom ratio may be determined based on the adjustment amount limit value. Digital zooming may be performed on the projection image of the projection display device, so that the projection image of the projection display device may avoid the obstacle point. In the embodiments, when the projection display device do not adjust the elevation angle of the projection lens, two modes including optical zooming and performing digital zooming on the projection image may be combined to adjust the projection image position of the projection display device, so as to ensure that the projection image of the projection display device may be accurately adjusted to a correct projection display position.

As an example, the operation of performing digital zooming on the projection image may include the following operations.

The first field of view angle of the projection display device in the current projection range and the point field of view angle of the obstacle point may be determined. A first projection parameter value required for the projection image to avoid the obstacle point may be detected based on the first field of view angle and the point field of view angle. A second projection parameter value after the projection parameter is adjusted to the adjustment amount limit value of the projection parameter may be determined. Digital zooming may be performed on the projection image based on the first projection parameter value and the second projection parameter value.

The projection parameter may include the projection ratio and the projection image aspect ratio of the projection display device.

In some embodiments, the first field of view angle of the projection display device in the current projection range and the point field of view angle of the obstacle point may be determined. The difference between the first field of view angle and the point field of view angle may be calculated. A first projection ratio required for the projection image of the projection display device to avoid the obstacle point may be calculated based on the difference, the first field of view angle of the projection display device, and the projection image aspect ratio of the projection display device. A second projection ratio after the projection parameter is adjusted to the adjustment amount limit value of the projection parameter may be determined. A ratio between the second projection ratio and the first projection ratio may function as the digital zoom ratio. Digital zooming may be performed on the projection image of the projection display device based on the digital zoom ratio while keeping a bottom edge of the projection image unchanged. In this way, in the embodiments, the digital zooming of the projection image may be controlled quantitatively, so as to ensure that the projection image after digital zooming may be projected and displayed on a correct projection display position.

As an example, the first projection ratio required for the projection image of the projection display device to avoid the obstacle point may be calculated based on the difference, the first field of view angle of the projection display device, and the projection image aspect ratio of the projection display device as follows.

$$tan ( {α}^{′} - {θ}^{′} ) = \frac{1}{{R}_{i} * {R}_{p}^{′}}$$

α′ may be the first field of view angle. θ′ may be the difference between the first field of view angle and the point field of view angle. Rᵢ may be the projection image aspect ratio. Rₚ′ may be the first projection ratio required for the projection image of the projection display device to avoid the obstacle point.

It should be understood that although the various operations in the flow charts in the above embodiments are shown in sequence based on the arrow indications, these operations may not necessarily be executed in sequence based on the arrow indications. Unless explicitly stated in the description, the execution of these operations may not have a strict order limit, and these operations may be executed in other orders. Moreover, at least some of the operations in the flow charts in the above embodiments may include a plurality of operations or a plurality of stages, and these operations or stages may not necessarily be executed at the same time, but may be executed at different times. An execution order of these operations or stages may not necessarily be sequential, but may be performed alternately or in turn with other operations or at least a part of operations or stages in other operations.

Based on the same concept, the embodiments of the present disclosure may further provide a projection display apparatus configured to implement the above-mentioned projection display method. The implementation solution configured to solve the problem provided by the apparatus may be similar to the implementation solution recorded in the above method, so the limitations in one or more embodiments of the projection display apparatus provided below may refer to the limitations on the projection display method in the above description, which will not be repeated herein.

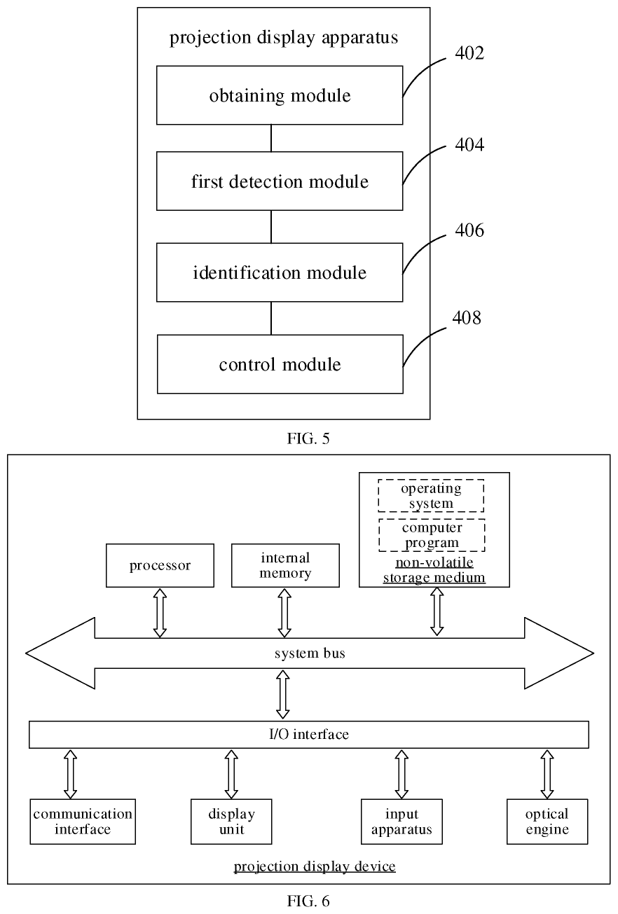

In some embodiments, as shown in FIG. 5, the projection display apparatus may be provided. The projection display apparatus may be applied to the projection display device. The apparatus may include an obtaining module 402, a first detection module 404, an identification module 406, and a control module 408.

The obtaining module 402 may be configured to obtain the point cloud data along the projection direction of the projection display device. The point cloud data may characterize the three-dimensional spatial positions of the plurality of detection points along the projection direction.

The first detection module 404 may be configured to identify the target projection plane based on the point cloud data.

The identification module 406 may be configured to identify the obstacle point not located on the target projection plane from the plurality of detection points based on the target projection plane and the point cloud data.

The control module 408 may be configured to control the projection display device to project the image that avoids the obstacle point in response to determining that the obstacle point is within the current projection range.

In some embodiments, the first detection module 404 may be further configured to: determine the plurality of sampling points from the plurality of detection points, and obtain the three-dimensional spatial position information of the plurality of sampling points from the point cloud data; perform plane fitting based on the three-dimensional spatial position information of the plurality of sampling points to obtain the target projection plane.

In some embodiments, the apparatus may further include a second detection module.

The second detection module may be configured to: detect the current projection range based on the projection ratio and the projection image aspect ratio of the projection display device; determine the lattice position information of the obstacle point, and detect whether the obstacle point is within the current projection range based on the lattice position information and the current projection range.

In some embodiments, the projection display device may include the optical engine. The optical engine may include the projection lens and the detection apparatus. The detection apparatus may be configured to detect the point cloud data. The current projection range may include the first field of view angle of the projection display device.

The second detection module may be further configured to: determine the view angle difference between the detection apparatus and the projection lens, and determine the second field of view angle of the detection apparatus along the preset direction based on the view angle difference and the first field of view angle; detect the point field of view angle of the obstacle point along the preset direction based on the lattice position information and the second field of view angle; determine that the obstacle point is within the current projection range in response to the point field of view angle being less than or equal to the first field of view angle; determine that the obstacle point is not within the current projection range in response to the point field of view angle being greater than the first field of view angle.

In some embodiments, the projection display device may include the motion mechanism. The current projection range may include the first field of view angle of the projection display device.

The control module may further be configured to: determine the adjustment angle of the motion mechanism based on the difference between the first field of view angle and the point field of view angle of the obstacle point; adjust the current projection range by using the motion mechanism based on the adjustment angle in response to the adjustment angle not exceeding the adjustment angle limit value of the motion mechanism, enabling the projection image of the projection display device to avoid the obstacle point.

In some embodiments, the projection display device may be capable of performing optical zooming, the control module may further be configured to: adjust the motion mechanism to the adjustment angle limit value in response to the adjustment angle exceeding the adjustment angle limit value of the motion mechanism, and determine the angle difference between the adjustment angle and the adjustment angle limit value; detect the first adjustment amount of the projection parameter of the projection display device based on the angle difference, the projection parameter including at least one of the projection ratio and the projection image aspect ratio; adjust the projection parameter based on the first adjustment amount in response to the first adjustment amount not exceeding the adjustment amount limit value of the projection parameter, so that the projection image of the projection display device may avoid the obstacle point; adjust the projection parameter to the adjustment amount limit value in response to the first adjustment amount exceeding the adjustment amount limit value of the projection parameter, and perform digital zooming on the projection image of the projection display device, so that the projection image of the projection display device may avoid the obstacle point.

In some embodiments, the projection display device may not capable of performing optical zooming, the control module may be further configured to: adjust the motion mechanism to the adjustment angle limit value in response to the adjustment angle exceeding the adjustment angle limit value of the motion mechanism, and determine the angle difference between the adjustment angle and the adjustment angle limit value; perform digital zooming on the projection image based on the angle difference, so that the projection image of the projection display device may avoid the obstacle point.

In some embodiments, the current projection range may include the first field of view angle of the projection display device. The control module may further be configured to: detect the second adjustment amount of the projection parameter of the projection display device based on the difference between the first field of view angle and the point field of view angle of the obstacle point, the projection parameter including at least one of the projection ratio or the projection image aspect ratio; adjust the projection parameter based on the second adjustment amount in response to the second adjustment amount not exceeding the adjustment amount limit value of the projection parameter, so that the projection image of the projection display device may avoid the obstacle point; adjust the projection parameter to the adjustment amount limit value of the projection parameter in response to the second adjustment amount exceeding the adjustment amount limit value of the projection parameter, and perform digital zooming on the projection image, so that the projection image of the projection display device may avoid the obstacle point.

In some embodiments, the control module may further be configured to: determine the first field of view angle of the projection display device in the current projection range and the point field of view angle of the obstacle point; detect the first projection parameter value required for the projection image to avoid the obstacle point based on the first field of view angle and the point field of view angle; determine the second projection parameter value after the projection parameter is adjusted to the adjustment amount limit value of the projection parameter; perform digital zooming on the projection image based on the first projection parameter value and the second projection parameter value.

Each module in the above projection display apparatus may be implemented in whole or in part by software, hardware, and a combination thereof. Each of the above modules may be embedded in or independent of a processor in the projection display device in the form of hardware, or may be stored in a memory in the projection display device in the form of software, so that the processor may call and execute operations corresponding to each of the above modules.

In some embodiments, an internal structural diagram of the projection display device may be as shown in FIG. 6. The projection display device may include an optical engine, a processor, a memory, an input/output (I/O) interface, a communication interface, a display unit, and an input apparatus. The optical engine may include a projection lens and a detection apparatus. The detection apparatus may be configured to detect and output point cloud data. The processor, the memory, and the input/output interface may be connected via a system bus. The communication interface, the display unit, and the input apparatus may be connected to the system bus via the input/output interface. The processor of the projection display device may be configured to provide computing and control capabilities. The memory of the projection display device may include a non-volatile storage medium and an internal memory. The non-volatile storage medium may store an operating system and a computer program. The internal memory may provide an operating environment for the operation of the operating system and the computer program in the non-volatile storage medium. The input/output interface of the projection display device may be configured to exchange information between the processor and an external device. The communication interface of the projection display device may be configured to communicate with an external terminal in a wired manner or a wireless manner. The wireless manner may be implemented via WIFI, a mobile cellular network, near field communication (NFC), or other technologies. The computer program may be configured to be executed by the processor to implement the projection display method. The display unit of the projection display device may be configured to form a visually visible image, and may include a display screen, a projection apparatus, or a virtual reality imaging apparatus. The display screen may be a liquid crystal display screen or an electronic ink display screen. The input apparatus of the projection display device may be a touch layer covered on the display screen, may be a key, a trackball, or a touch pad disposed on a housing of the projection display device, or may be an external keyboard, an external touch pad, an external mouse, or the like.

Those skilled in the art may understand that the structure shown in FIG. 6 may be only a block diagram of a part of the structure related to the solution of the present disclosure, and may not constitute a limitation on the projection display device to which the solution of the present disclosure is applied. The projection display device may include more or fewer components than those shown in the drawing, or combine some components, or have different component arrangements.

In some embodiments, the projection display device may be provided. The projection device may include an optical engine, a memory, and a processor. The memory may be configured to store a computer program. The processor may be configured to execute the computer program to implement the operations in each of the above method embodiments.

In some embodiments, a computer-readable storage medium may be provided. A computer program may be stored in the computer-readable storage medium. The computer program may be configured to be executed by a processor to implement the operations in each of the above method embodiments.

In some embodiments, a computer program product may be provided. The computer program product may include a computer program. The computer program may be configured to be executed by a processor to implement the operations in each of the above method embodiments.

Those of ordinary skill in the art may understand that all or part of the processes in the methods of the above embodiments may be implemented by instructing relevant hardware via a computer program. The computer program may be stored in a non-volatile computer-readable storage medium. In response to the computer program being executed, the processes of the above method embodiments may be included. Any reference to the memory, a database, or other media involved in the various embodiments provided in the present disclosure may include at least one of a non-volatile memory or a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM), an external cache memory, and the like. By way of illustration and not limitation, the RAM may be in various forms, such as a static random access memory (SRAM), a dynamic random access memory (DRAM), and the like. Any database involved in the various embodiments provided in the present disclosure may include at least one of a relational database or a non-relational database. The non-relational database may include a distributed database based on a blockchain and the like, which is not limited thereto. Any processor involved in the various embodiments provided in the present disclosure may be a general-purpose processor, a central processing unit (CPU), a graphics processing unit (GPU), a digital signal processor (DSP), a programmable logic device, a data processing logic device based on quantum computing, an artificial intelligence (AI) processor, and the like, which is not limited thereto.

The various technical features of the above embodiments may be combined arbitrarily. For the sake of concise description, not all possible combinations of the various technical features in the above embodiments are described. However, as long as there is no contradiction in the combination of these technical features, all of the combination may be considered as the scope of the present disclosure.

The above embodiments only express several implementation modes of the present disclosure, and the description thereof may be relatively specific and detailed, but may not therefore be understood as a limitation on the patent scope of the present disclosure. It should be pointed out that for those of ordinary skill in the art, a number of modifications and improvements may be made without departing from the concept of the present disclosure, and these modifications and improvements may all fall within the protection scope of the present disclosure. Therefore, the protection scope of the present disclosure shall be subject to the appended claims.

1. A projection display method, applied to a projection display device and comprising:
obtaining point cloud data along a projection direction of the projection display device, wherein the point cloud data characterizes three-dimensional spatial positions of a plurality of detection points along the projection direction;
identifying a target projection plane based on the point cloud data;
identifying an obstacle point not located on the target projection plane from the plurality of detection points based on the target projection plane and the point cloud data;
controlling, in response to determining that the obstacle point is within a current projection range, the projection display device to project an image that avoids the obstacle point.

2. The method according to claim 1, wherein identifying the target projection plane based on the point cloud data, comprises:
determining a plurality of sampling points from the plurality of detection points, and obtaining three-dimensional spatial position information of the plurality of sampling points from the point cloud data;
performing plane fitting based on the three-dimensional spatial position information of the plurality of sampling points to obtain the target projection plane.

3. The method according to claim 1, wherein before controlling, in response to determining that the obstacle point is within the current projection range, the projection display device to project the image that avoids the obstacle point, the method further comprises:
detecting the current projection range based on a projection ratio and a projection image aspect ratio of the projection display device;
determining lattice position information of the obstacle point, and detecting whether the obstacle point is within the current projection range based on the lattice position information and the current projection range.

4. The method according to claim 3, wherein the projection display device comprises an optical engine, the optical engine comprises a projection lens and a detection apparatus, the detection apparatus is configured to detect the point cloud data, and the current projection range comprises a first field of view angle of the projection display device; detecting whether the obstacle point is within the current projection range based on the lattice position information and the current projection range, comprises:
determining a view angle difference between the detection apparatus and the projection lens, and determining a second field of view angle of the detection apparatus along a preset direction based on the view angle difference and the first field of view angle;
detecting a point field of view angle of the obstacle point along the preset direction based on the lattice position information and the second field of view angle;
determining, in response to the point field of view angle being less than or equal to the first field of view angle, that the obstacle point is within the current projection range;
determining, in response to the point field of view angle being greater than the first field of view angle, that the obstacle point is not within the current projection range.

5. The method according to claim 1, wherein the projection display device comprises a motion mechanism, and the current projection range comprises a first field of view angle of the projection display device; controlling the projection display device to project the image that avoids the obstacle point, comprises:
determining an adjustment angle of the motion mechanism based on a difference between the first field of view angle and a point field of view angle of the obstacle point;
adjusting, in response to the adjustment angle not exceeding an adjustment angle limit value of the motion mechanism, the current projection range by using the motion mechanism based on the adjustment angle, to cause a projection image of the projection display device to avoid the obstacle point.

6. The method according to claim 5, wherein the projection display device is capable of performing optical zooming, the method further comprises:
adjusting, in response to the adjustment angle exceeding the adjustment angle limit value of the motion mechanism, the motion mechanism to the adjustment angle limit value, and determining an angle difference between the adjustment angle and the adjustment angle limit value;
detecting a first adjustment amount of a projection parameter of the projection display device based on the angle difference, wherein the projection parameter comprises at least one of a projection ratio or a projection image aspect ratio;
adjusting, in response to the first adjustment amount not exceeding an adjustment amount limit value of the projection parameter, the projection parameter based on the first adjustment amount, to cause the projection image to avoid the obstacle point;
adjusting, in response to the first adjustment amount exceeding the adjustment amount limit value of the projection parameter, the projection parameter to the adjustment amount limit value, and performing digital zooming on the projection image, to cause the projection image to avoid the obstacle point.

7. The method according to claim 5, wherein the projection display device is not capable of performing optical zooming, the method further comprises:
adjusting, in response to the adjustment angle exceeding the adjustment angle limit value of the motion mechanism, the motion mechanism to the adjustment angle limit value, and determining an angle difference between the adjustment angle and the adjustment angle limit value;
performing digital zooming on the projection image based on the angle difference, to cause the projection image to avoid the obstacle point.

8. The method according to claim 1, wherein the current projection range comprises a first field of view angle of the projection display device; controlling the projection display device to project the image that avoids the obstacle point, comprises:
detecting a second adjustment amount of a projection parameter of the projection display device based on a difference between the first field of view angle and a point field of view angle of the obstacle point, wherein the projection parameter comprises at least one of a projection ratio or a projection image aspect ratio;
adjusting, in response to the second adjustment amount not exceeding an adjustment amount limit value of the projection parameter, the projection parameter based on the second adjustment amount, to cause a projection image of the projection display device to avoid the obstacle point;
adjusting, in response to the second adjustment amount exceeding the adjustment amount limit value of the projection parameter, the projection parameter to the adjustment amount limit value of the projection parameter, and performing digital zooming on the projection image, to cause the projection image to avoid the obstacle point.

9. The method according to claim 6, wherein performing digital zooming on the projection image, comprises:
determining the first field of view angle of the projection display device in the current projection range and the point field of view angle of the obstacle point;
detecting a first projection parameter value required for the projection image to avoid the obstacle point based on the first field of view angle and the point field of view angle;
determining a second projection parameter value after the projection parameter is adjusted to the adjustment amount limit value of the projection parameter;
performing digital zooming on the projection image based on the first projection parameter value and the second projection parameter value.

10. The method according to claim 1, wherein identifying the target projection plane based on the point cloud data, comprises:
performing plane fitting on the plurality of detection points based on the point cloud data to obtain a plurality of fitting planes;
determining a fitting plane comprising the most detection points from the plurality of fitting planes as the target projection plane.

11. The method according to claim 1, wherein identifying the obstacle point not located on the target projection plane from the plurality of detection points based on the target projection plane and the point cloud data, comprises:
identifying whether three-dimensional position information of each of the plurality of detection points conforms to a projection plane equation of the target projection plane;
determining, in response to three-dimensional position information of one of the plurality of detection points not conforming to the projection plane equation of the target projection plane, that the one of the plurality of detection points is the obstacle point not located on the target projection plane.

12. The method according to claim 1, wherein the projection display device comprises a projection lens, controlling the projection display device to project the image that avoids the obstacle point, comprises:
adjusting at least one of a projection parameter of the projection display device or an elevation angle of the projection lens to control the projection display device to project the image that avoids the obstacle point.

13. The method according to claim 3, wherein the current projection range is represented by a current horizontal field of view angle and a current vertical field of view angle of the projection display device; detecting the current projection range based on the projection ratio and the projection image aspect ratio of the projection display device, comprises:
detecting the current horizontal field of view angle of the projection display device based on the projection ratio of the projection display device;
detecting the current vertical field of view angle of the projection display device based on the projection ratio and the projection image aspect ratio of the projection display device.

14. The method according to claim 6, wherein performing digital zooming on the projection image, comprises:
determining the first field of view angle of the projection display device in the current projection range and the point field of view angle of the obstacle point;
detecting the difference between the first field of view angle and the point field of view angle, and detecting a first projection ratio required for the projection image to avoid the obstacle point based on the difference between the first field of view angle and the point field of view angle, the first field of view angle of the projection display device, and the projection image aspect ratio of the projection display device;
determining a second projection ratio after the projection parameter is adjusted to the adjustment amount limit value of the projection parameter, and determining a ratio between the second projection ratio and the first projection ratio as a digital zoom ratio;
performing digital zooming on the projection image based on the digital zoom ratio with a bottom edge of the projection image maintained unchanged.

15. A projection display device, comprising an optical engine, a memory, and a processor, wherein the memory is configured to store a computer program, the processor is configured to execute the computer program to implement a projection display method, and the method comprises:
obtaining point cloud data along a projection direction of the projection display device, wherein the point cloud data characterizes three-dimensional spatial positions of a plurality of detection points along the projection direction;
identifying a target projection plane based on the point cloud data;
identifying an obstacle point not located on the target projection plane from the plurality of detection points based on the target projection plane and the point cloud data;
controlling, in response to determining that the obstacle point is within a current projection range, the projection display device to project an image that avoids the obstacle point.

16. The projection display device according to claim 15, wherein identifying the target projection plane based on the point cloud data, comprises:
determining a plurality of sampling points from the plurality of detection points, and obtaining three-dimensional spatial position information of the plurality of sampling points from the point cloud data;
performing plane fitting based on the three-dimensional spatial position information of the plurality of sampling points to obtain the target projection plane.

17. The projection display device according to claim 15, wherein before controlling, in response to determining that the obstacle point is within the current projection range, the projection display device to project the image that avoids the obstacle point, the method further comprises:
detecting the current projection range based on a projection ratio and a projection image aspect ratio of the projection display device;
determining lattice position information of the obstacle point, and detecting whether the obstacle point is within the current projection range based on the lattice position information and the current projection range.

18. The projection display device according to claim 15, wherein the projection display device comprises a motion mechanism, and the current projection range comprises a first field of view angle of the projection display device; controlling the projection display device to project the image that avoids the obstacle point, comprises:
determining an adjustment angle of the motion mechanism based on a difference between the first field of view angle and a point field of view angle of the obstacle point;
adjusting, in response to the adjustment angle not exceeding an adjustment angle limit value of the motion mechanism, the current projection range by using the motion mechanism based on the adjustment angle, to cause a projection image of the projection display device to avoid the obstacle point.

19. The projection display device according to claim 15, wherein the current projection range comprises a first field of view angle of the projection display device; controlling the projection display device to project the image that avoids the obstacle point, comprises:
detecting a second adjustment amount of a projection parameter of the projection display device based on a difference between the first field of view angle and a point field of view angle of the obstacle point, wherein the projection parameter comprises at least one of a projection ratio or a projection image aspect ratio;
adjusting, in response to the second adjustment amount not exceeding an adjustment amount limit value of the projection parameter, the projection parameter based on the second adjustment amount, to cause a projection image of the projection display device to avoid the obstacle point;
adjusting, in response to the second adjustment amount exceeding the adjustment amount limit value of the projection parameter, the projection parameter to the adjustment amount limit value of the projection parameter, and performing digital zooming on the projection image, to cause the projection image to avoid the obstacle point.

20. The projection display device according to claim 19, wherein performing digital zooming on the projection image, comprises:
determining the first field of view angle of the projection display device in the current projection range and the point field of view angle of the obstacle point;
detecting a first projection parameter value required for the projection image to avoid the obstacle point based on the first field of view angle and the point field of view angle;
determining a second projection parameter value after the projection parameter is adjusted to the adjustment amount limit value of the projection parameter;
performing digital zooming on the projection image based on the first projection parameter value and the second projection parameter value.
